(19) United States
(12) Patent Application Publication
(10) Pub. No.: US 2006/0035805 A1
(43) Pub. Date: Feb. 16, 2006

(54) Bleach-containing laundry detergent comprising cotton-active soil release-capable cellulose derivative

(76) Inventor: Josef Penninger, Hilden (DE)

Correspondence Address: DANN DORFMAN HERRELL AND SKILLMAN;A PROFESSIONAL CORPORATION, 1601 MARKET STREET, SUITE 2400, PHILADELPHIA, PA, 19103-2307, US

(21) Appl. No.: 11/201,261

(22) Filed: Aug. 10, 2005

Related U.S. Application Data
(63) Continuation of application No. PCT/EP04/00869, filed on Jan. 31, 2004.

(30) Foreign Application Priority Data
Feb. 10, 2003 (DE) DE 103 05 306.9
Oct. 31, 2003 (DE) DE 103 51 322.1

(51) Int. Cl. C11D 3/22

(52) U.S. Cl. 510/473

(57) ABSTRACT

Textile materials comprised at least partially of cotton are cleaned with a laundry detergent comprising bleach and an alkylated and/or hydroxyalkylated soil release-capable cellulose derivative having an average of from 0.5 to 2.5 alkyl groups and/or from 0.02 to 0.5 hydroxyalkyl groups per anhydroglycose monomer unit. The textile materials are cleaned more effectively with a laundry detergent containing the alkylated and/or hydroxyalkylated soil release-capable cellulose derivative.

### CROSS-REFERENCE TO RELATED APPLICATIONS.

This application is a continuation under § 365 (c) and 35 U.S.C. § 120 of international application PCT/2004/000869, filed Jan. 31, 2004. This application also claims priority under 35 U.S.C. § 119 of DE 103 05 306.9, filed Feb. 10, 2003 and of DE 103 51 322.1, filed Oct. 31, 2003, each of which is incorporated herein by reference in its entireties.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

(1) Field of the Invention

The present invention relates to the use of certain soil release-capable cellulose derivatives for enhancing the cleaning power of bleach-containing laundry detergents in the washing of textiles, in particular those which consist of cotton or comprise cotton, and also to bleach-containing laundry detergents and cleaning compositions which comprise such soil release-capable cellulose derivatives.

In addition to the ingredients which are indispensable for the washing process, such as surfactants and builder materials, laundry detergents generally comprise further constituents which can be summarized under the term washing assistants and which comprise such different active substance groups as foam regulators, graying inhibitors, bleaches, bleach activators and dye transfer inhibitors. Such assistants also includes substances which impart to the laundry fiber soil-repellent properties and which, if present during the washing operation, are capable of promoting the soil release capability of the remaining laundry detergent constituents. The same applies mutatis mutandis for cleaning compositions for hard surfaces. Such soil release-capable substances are often referred to as “soil release” active substances or, owing to their capability of modifying the treated surface, for example of the fiber, in a soil-repellent manner, as “soil repellents.” For example, the American patent U.S. Pat. No. 4,136,038 discloses the soil release-capable action of methylcellulose. The European patent application EP 0 213 729 discloses the reduced redeposition in the case of use of laundry detergents which comprise a combination of soap and non-ionic surfactant comprising alkylhydroxyalkylcellulose. The European patent application EP 0 213 730 discloses textile treatment compositions which comprise cationic surfactants and non-ionic cellulose ethers having HLB values of from 3.1 to 3.8. The American patent U.S. Pat. No. 4,000,093 discloses laundry detergents which comprise from 0.1% by weight to 3% by weight of alkylcellulose, hydroxyalkylcellulose or alkylhydroxyalkylcellulose, and also from 5% by weight to 50% by weight of surfactant, the surfactant component consisting substantially of C₁₀- to C₁₃-alkyl sulfate and having up to 5% by weight of C₁₄-alkyl sulfate and fewer than 5% by weight of alkyl sulfate having alkyl radicals of C₁₅ and higher. The American patent U.S. Pat. No. 4,174,305 discloses laundry detergents which comprise from 0.1% by weight to 3% by weight of alkylcellulose, hydroxyalkylcellulose or alkylhydroxyalkylcellulose, and also from 5% by weight to 50% by weight of surfactant, the surfactant component consisting substantially of C₁₀- to C₁₂-alkylbenzenesulfonate and having fewer than 5% by weight of alkylbenzenesulfonate having alkyl radicals of C₁₃ and higher. The European patent EP 0 271 312 relates to soil release-capable active substances, and among these cellulose alkyl ethers and cellulose hydroxylalkyl ethers (having DS from 1.5 to 2.7 and molar masses of from 2000 to 100 000) such as methylcellulose and ethylcellulose, which are to be used with peroxygen bleach in a weight ratio (based on the active oxygen content of the bleach) of from 10:1 to 1:10. The European patent application EP 0 634 481 relates to a laundry detergent which comprises alkali metal percarbonate and one or more non-ionic cellulose derivatives. Among the latter, explicitly disclosed are merely hydroxyethylcellulose, hydroxypropylcellulose and methylcellulose, and also, within the examples, the methylhydroxyethylcellulose Tylose® MH50, the hydroxypropylmethylcellulose Methocel® F4M and hydroxybutylmethylcellulose. The European patent EP 0 948 591 B1 discloses a laundry detergent in liquid or granular form which imparts to fabrics and textiles which are washed therewith textile appearance advantages such as pilling/fuzz reduction, counteraction of dye fading, improved attrition resistance and/or enhanced softness, and which contains from 1 to 80% by weight of surfactant, from 1 to 80% by weight of organic or inorganic builder, from 0.1 to 80% by weight of a hydrophobically modified non-ionic cellulose ether having a molar mass of from 10 000 to 2 000 000, the modification consisting in the presence of optionally oligomerized (degree of oligomerization up to 20) ethyleneoxy or 2-propyleneoxy ether units and of C₈₋₂₄-alkyl substituents, and the alkyl substituents having to be present in amounts of 0.1-5% by weight based on the cellulose ether material.

Owing to their chemical similarity to polyester fibers, particularly effective soil release-capable active ingredients in the case of textiles composed of this material are copolyesters which contain dicarboxylic acid units, alkylene glycol units and polyalkylene glycol units. Soil release-capable copolyesters of the type mentioned and also their use in laundry detergents have been known for some time.

(2) Description of Related Art, Including Information Disclosed Under 37 C.F.R. §§ 1.97 and 1.98.

For example, the German laid-open specification DT 16 17 141 describes a washing process using polyethylene terephthalate-polyoxyethylene glycol copolymers. The German laid-open specification DT 22 00 911 relates to laundry detergents which comprise non-ionic surfactant and a copolymer composed of polyoxyethylene glycol and polyethylene terephthalate. The German laid-open specification DT 22 53 063 mentions acidic textile modifying compositions which comprise a copolymer composed of a dibasic carboxylic acid and an alkylene polyglycol or cycloalkylene polyglycol, and also optionally an alkylene glycol or cycloalkylene glycol. Polymers composed of ethylene terephthalate and polyethylene oxide terephthalate in which the polyethylene glycol units have molar masses of from 750 to 5000 and the molar ratio of ethylene terephthalate to polyethylene oxide terephthalate is from 50:50 to 90:10, and their use in laundry detergents are described in the German patent DE 28 57 292. Polymers having molar mass from 15 000 to 50 000 and composed of ethylene terephthalate and polyethylene oxide terephthalate, the polyethylene glycol units having molar masses of from 1000 to 10 000 and the molar ratio of ethylene terephthalate to polyethylene oxide terephthalate being from 2:1 to 6:1, can be used in laundry detergents according to the German laid-open specification DE 33 24 258. The European patent EP 066 944 relates to textile treatment compositions which comprise a copolyester composed of ethylene glycol, polyethylene glycol, aromatic dicarboxylic acid and sulfonated aromatic dicarboxylic acid in certain molar ratios. The European patent EP 185 427 discloses polyesters which are end group-capped by methyl or ethyl groups and have ethylene terephthalate and/or propylene terephthalate and polyethylene oxide terephthalate units, and laundry detergents which comprise such soil release polymers. The European patent EP 241 984 relates to a polyester which, in addition to oxyethylene groups and terephthalic acid units, also contains substituted ethylene units and glycerol units. The European patent EP 241 985 discloses polyesters which, in addition to oxyethylene groups and terephthalic acid units, contain 1,2-propylene, 1,2-butylene and/or 3-methoxy-1,2-propylene groups and also glycerol units, and are end group-capped with C₁- to C₄-alkyl groups. The European patent EP 253 567 relates to soil release polymers which have a molar mass of from 900 to 9000 and are composed of ethylene terephthalate and polyethylene oxide terephthalate, the polyethylene glycol units having molar masses of from 300 to 3000 and the molar ratio of ethylene terephthalate to polyethylene oxide terephthalate being from 0.6 to 0.95. The European patent application EP 272 033 discloses polyesters which are at least partly end group-capped by C₁₋₄-alkyl or acyl radicals and have polypropylene terephthalate and polyoxyethylene terephthalate units. The European patent EP 274 907 describes terephthalate-containing soil release polyesters which are end group-capped by sulfoethyl. In the European patent application EP 357 280, soil release polyesters having terephthalate, alkylene glycol and poly-C₂₋₄-glycol units are prepared by sulfonation of unsaturated end groups. The German patent application DE 26 55 551 describes the reaction of such polyesters with isocyanate-containing polymers and the use of the thus prepared polyesters against the reattachment of soil in the course of washing of synthetic fibers. The German patent application DE 28 46 984 discloses laundry detergents which comprise, as a soil release-capable polymer, a reaction product of a polyester with a prepolymer containing terminal isocyanate groups, obtained from a diisocyanate and a hydrophilic non-ionic macrodiol.

The polymers known from this extensive prior art have the disadvantage that, in the case of textiles which do not consist, or at least do not consist predominantly, of polyester, they only have insufficient, if any, effectiveness. However, a large part of modern textiles consists of cotton or cotton-polyester mixed fabrics, so that there is a need for soil release-capable active substances having better activity in the case of in particular greasy stains on such textiles. Furthermore, such soil release-capable active ingredients not only have to be stable in the presence of bleaches normally present in laundry detergents, but should have particularly good activity specifically in such bleach-containing compositions and desirably even improve the activity of the bleach or at least do not impair it.

It has been found that, surprisingly, this object can be achieved by the use of certain cellulose derivates.

### BRIEF SUMMARY OF THE INVENTION

The invention provides for the use of a combination of soil release-capable cellulose derivative which is obtainable by alkylation and hydroxyalkylation of cellulose, and bleach for enhancing the cleaning action of laundry detergents in the washing of textiles which in particular consist of cotton or comprise cotton.

The invention further provides a process for washing textiles, in which a bleach-containing laundry detergent and a soil release-capable cellulose derivative which is obtainable by alkylation and hydroxyalkylation of cellulose is used. This process may be performed manually or preferably with the aid of a customary domestic washing machine. It is possible to use the bleach-containing laundry detergent and the soil release-capable cellulose derivative simultaneously or successively. The simultaneous use can be carried out particularly advantageously by the use of a bleach-containing laundry detergent which comprises the soil release-capable cellulose derivative.

### BRIEF DESCRIPTION OF THE SEVERAL VIEWS OF THE DRAWING(s)

Not Applicable

### DETAILED DESCRIPTION OF THE INVENTION

The washing performance-enhancing effect of the cellulose derivatives to be used in accordance with the invention on repeated use, i.e. in particular for the removal of stains from appropriate textiles which have already been washed and/or after-treated in the presence of the cellulose derivative before they have been stained. In connection with the after-treatment, it should be pointed out that the positive aspect indicated can also be realized by a washing process in which the textile, after the actual washing operation which is performed with the aid of a bleach-containing laundry detergent (which may comprise said cellulose derivative but in this case may also be free thereof), is contacted with an after-treatment composition, for example in a fabric softening step, which comprises a cellulose derivative to be used in accordance with the invention. In this procedure too, even if, if desired, a bleach-containing laundry detergent is used but no laundry detergent comprising said cellulose derivative is used in the next washing operation, the washing performance-enhancing effect of the cellulose derivative to be used in accordance with the invention occurs.

Preferred cellulose derivatives are those which have been alkylated with C₁ to C₁₀ groups, in particular C₁ to C₃ groups, and additionally bear C₂ to C₁₀ hydroxyalkyl groups, in particular C₂ to C₃ hydroxyalkyl groups. These can be obtained in a known manner by reacting cellulose with appropriate alkylating agents, for example alkyl halides or alkyl sulfates, and subsequent reaction with appropriate alkylene oxides, for example ethylene oxide and/or propylene oxide. In a preferred embodiment of the invention, the cellulose derivative contains on average from 0.5 to 2.5, in particular from 1 to 2, alkyl groups, and from 0.02 to 0.5, in particular from 0.05 to 0.3, hydroxyalkyl group per anhydroglycose monomer unit. The average molar mass of the cellulose derivatives used in accordance with the invention is preferably in the range from 10 000 D to 150 000 D, in particular from 40 000 D to 120 000 D and more preferably in the range from 80 000 D to 110 000 D. The determination of the degree of polymerization and of the molecular weight of the soil release-capable cellulose derivative is based on the determination of the limiting viscosity number on sufficiently dilute aqueous solutions by means of an Ubbelohde capillary viscometer (Oc capillary). Using a constant [H. Staudinger and F. Reinecke, “Über Molekulargewichtsbestimmung an Celluloseethern” [On molecular weight determination of cellulose ethers], Liebigs Annalen der Chemie 535, 47 (1938)] and a correction factor [F. Rodriguez and L. A. Goettler, “The Flow of Moderately Concentrated Polymer Solutions in Water”, Transactions of the Society of Rheology VIII, 3 17 (1964)] it is possible to calculate therefrom the degree of polymerization and, with incorporation of the degrees of substitution (DS and MS), the corresponding molecular weight.

As stated, the cellulose derivatives used in accordance with the invention can be prepared in a simple manner and are both ecologically and toxicologically safe. They lead to significantly better removal of especially grease and cosmetic stains on cotton or cotton-containing fabrics than is the case when compounds known to date for this purpose are used. Alternatively, significant amounts of surfactants can be saved for equal grease removal capability.

In the context of a washing process, the inventive use may be such that a bleach and the cellulose derivative are added to a laundry detergent-containing liquor, the cellulose derivative is added separately to a bleach- and laundry detergent-containing liquor, or, preferably, the cellulose derivative is introduced into the liquor as a constituent of a bleach-containing laundry detergent. The invention therefore also provides a bleach-containing laundry detergent which comprises an above-described cellulose derivative.

In the context of a laundry after-treatment process, the inventive use may correspondingly be such that the cellulose derivative is added separately to the rinse liquor which is used after the washing cycle executed with use of a bleach-containing laundry detergent, or that it is introduced as a constituent of the laundry after-treatment composition, in particular a fabric softener. In this aspect of the invention, said bleach-containing laundry detergent may likewise be a cellulose derivative to be used in accordance with the invention, but may also be free thereof. Conversely, said laundry after-treatment composition may also comprise a bleach, but may also be free thereof.

A composition which comprises a cellulose derivative to be used in accordance with the invention or is used together with it or is used in the process according to the invention comprises bleaches, preferably peroxygen-based, in particular in amounts in the range from 5% by weight to 70% by weight, and also optionally bleach activator, in particular in amounts of from 2% by weight to 10% by weight. The useful bleaches are preferably the peroxygen compounds generally used in laundry detergents, such as percarboxylic acids, for example dodecanediperacid or phthaloylaminoperoxycaproic acid, hydrogen peroxide, alkali metal perborate which may be present as the tetra- or monohydrate, percarbonate, perpyrophosphate and persilicate, which are present generally as alkali metal salts, in particular as sodium salts. Such bleaches are present in laundry detergents which comprise a cellulose derivative used in accordance with the invention preferably in amounts up to 25% by weight, in particular up to 15% by weight and more preferably from 5% by weight to 15% by weight, based in each case on overall composition, percarbonate in particular being used. The optionally present component of the bleach activators comprises the customarily used N- or O-acyl compounds, for example polyacylated alkylenediamines, in particular tetraacetylethylenediamine, acylated glycolurils, in particular tetraacetylglycoluril, N-acylated hydantoins, hydrazides, triazoles, urazoles, diketopiperazines, sulfurylamides and cyanurates, and also carboxylic anhydrides, in particular phthalic anhydride, carboxylic esters, in particular sodium isononanoylphenolsulfonate, and acylated sugar derivatives, in particular pentaacetylglucose, and also cationic nitrile derivatives such as trimethylammonioacetonitrile salts. To prevent interaction with the per compounds in the course of storage, the bleach activators may have been coated in a known manner with coating substances or granulated, in which case particular preference is given to tetraacetylethylenediamine which has been granulated with the aid of carboxymethylcellulose and has average particle sizes of from 0.01 mm to 0.8 mm, as can be prepared, for example, by the process described in the European patent EP 37 026, granulated 1,5-diacetyl-2,4-dioxohexahydro-1,3,5-triazine, as can be prepared by the process described in the German patent DD 255 884, and/or trialkylammonioacetonitrile formulated in particulate form by the processes described in the international patent applications WO 00/50553, WO 00/50556, WO 02/12425, WO 02/12426 or WO 02/26927. Laundry detergents comprise such bleach activators preferably in amounts of up to 8% by weight, in particular from 2% by weight to 6% by weight, based in each case on overall composition.

Bleach-containing laundry detergents which comprise a cellulose derivative to be used in accordance with the invention or are used together with it or, in the process according to the invention may comprise all customary other constituents of such compositions which do not interact in an undesired manner with the cellulose derivative which is essential to the invention. The cellulose derivative is incorporated into bleach-containing laundry detergents preferably in amounts of from 0.1% by weight to 5% by weight, in particular from 0.5% by weight to 2.5% by weight.

It has been found that, surprisingly, such cellulose derivatives having the above-specified properties positively influence the action of certain other laundry detergent and cleaning composition ingredients and that, conversely, the action of the cotton-active soil release cellulose derivative is additionally enhanced by certain other laundry detergent ingredients. These effects occur in particular in the case of active enzymatic ingredients, in particular proteases and lipases, in the case of water-soluble organic builders, in particular based on oxidized carbohydrates or polymeric polycarboxylates, in the case of sulfate- and sulfonate-type synthetic anionic surfactants, in the case of dye transfer inhibitors, for example vinylpyrrolidone, vinylpyridine or vinylimidazole polymers or copolymers, or corresponding polybetaines, and in the case of graying inhibitors, for example other, especially anionic, cellulose ethers such as carboxymethylcellulose, which is why the use of at least one of the further ingredients mentioned together with cellulose derivatives to be used in accordance with the invention is preferred.

In a preferred embodiment, an inventive composition, a composition used in accordance with the invention or a composition used in the process according to the invention comprises non-ionic surfactant selected from fatty alkyl polyglycosides, fatty alkyl polyalkoxylates, in particular ethoxylates and/or propoxylates, fatty acid polyhydroxy amides and/or ethoxylation and/or propoxylation products or fatty alkyl amines, vicinal diols, fatty acid alkyl esters and/or fatty acid amides and mixtures thereof, in particular in an amount in the range from 2% by weight to 25% by weight.

A further embodiment of such compositions includes the presence of synthetic sulfate- and/or sulfonate-type anionic surfactant, in particular fatty alkyl sulfate, fatty alkyl ether sulfate, sulfo fatty acid esters and/or sulfo fatty acid disalts, in particular in an amount in the range from 2% by weight to 25% by weight. The anionic surfactant is preferably selected from the alkyl or alkenyl sulfates and/or the alkyl or alkenyl ether sulfates, in which the alkyl or alkenyl group has from 8 to 22, in particular from 12 to 18, carbon atoms. These are typically not single substances but rather cuts or mixtures. Among these, preference is given to those whose fraction of compounds having longer-chain radicals in the range from 16 to 18 carbon atoms is above 20%.

The useful non-ionic surfactants include the alkoxylates, in particular the ethoxylates and/or propoxylates, of saturated or mono- or polyunsaturated linear or branched-chain alcohols having from 10 to 22 carbon atoms, preferably from 12 to 18 carbon atoms. The degree of alkoxylation of the alcohols is generally between 1 and 20, preferably between 3 and 10. They can be prepared in a known manner by reacting the appropriate alcohols with the appropriate alkylene oxides. Especially suitable are the derivatives of fatty alcohols, although their branched-chain isomers, in particular what are known as oxo alcohols, can also be used to prepare usable alkoxylates. Accordingly usable are the alkoxylates, in particular the ethoxylates, of primary alcohols with linear radicals, especially dodecyl, tetradecyl, hexadecyl or octadecyl radicals, and mixtures thereof. Also usable are corresponding alkoxylation products of alkylamines, vicinal diols and carboxamides which correspond to the alcohols mentioned with regard to the alkyl moiety. Also useful are the ethylene oxide and/or propylene oxide insertion products of fatty acid alkyl esters, as can be prepared by the process specified in the international patent application WO 90/13533, and also fatty acid polyhydroxy amides, as can be prepared by the processes of the American patents U.S. Pat. No. 1,985,424, U.S. Pat. No. 2,016,962 and U.S. Pat. No. 2,703,798 and of the international patent application WO 92/06984. Alkylpolyglycosides which are suitable for incorporation into the inventive compositions are compounds of the general formula (G)ₙ—OR¹² in which R¹² is an alkyl or alkenyl radical having from 8 to 22 carbon atoms, G is a glycose unit and n is from 1 to 10. Such compounds and their preparation are described, for example, in the European patent applications EP 92 355, EP 301 298, EP 357 969 and EP 362 671, or the American patent U.S. Pat. No. 3,547,828. The glycoside component (G)ₙ is oligo- or polymers composed of naturally occurring aldose or ketose monomers, which include in particular glucose, mannose, fructose, galactose, talose, gulose, altrose, allose, idose, ribose, arabinose, xylose and lyxose. The oligomers consisting of such glycosidically linked monomers are characterized, apart from by the type of sugars present therein, by the number thereof, known as the degree of oligomerization. The degree of oligomerization n, as a parameter to be determined analytically, generally assumes fractional numerical values; it is from 1 to 10, and below a value of 1.5 in the case of the glycosides used with preference, in particular between 1.2 and 1.4. Owing to the good availability, a preferred monomer unit is glucose. The alkyl or alkenyl moiety R¹² of the glycosides preferably likewise stems from readily obtainable derivatives of renewable raw materials, in particular from fatty alcohols, although the branched-chain isomers, in particular oxo alcohols, can also be used to prepare usable glycosides. Accordingly usable are in particular the primary alcohols having linear octyl, decyl, dodecyl, tetradecyl, hexadecyl or octadecyl radicals and mixtures thereof. Particularly preferred alkylglycosides contain a coconut fatty alkyl radical, i.e. mixtures having substantially

R¹²=dodecyl and

R¹²=tetradecyl.

Non-ionic surfactant is present in compositions which comprise a soil release active ingredient used in accordance with the invention, compositions which are used in accordance with the invention or compositions which are used in the process according to the invention preferably in amounts of from 1% by weight to 30% by weight, in particular from 1 % by weight to 25% by weight, amounts in the upper part of this range being encountered mainly in liquid laundry detergents and particulate laundry detergents preferentially containing somewhat smaller amounts of up to 5% by weight.

Instead of this or in addition, the compositions may comprise further surfactants, preferably sulfate- or sulfonate-type synthetic anionic surfactants, for example alkylbenzenesulfonates, in amounts of preferably not more than 20% by weight, in particular from 0.1% by weight to 18% by weight, based in each case on overall composition. Synthetic anionic surfactants particularly suitable for use in such compositions are the alkyl and/or alkenyl sulfates having from 8 to 22 carbon atoms, which bear an alkali metal, ammonium or alkyl- or hydroxyalkyl-substituted ammonium ion as a countercation. Preference is given to the derivatives of fatty alcohols having in particular from 12 to 18 carbon atoms and their branched-chain analogs, known as the oxo alcohols. The alkyl and alkenyl sulfates can be prepared in a known manner by reaction of the corresponding alcohol component with a customary sulfation reagent, in particular sulfur trioxide or chlorosulfonic acid, and subsequent neutralization with alkali metal, ammonium or alkyl- or hydroxyalkyl-substituted ammonium bases. The usable sulfate-type surfactants also include the sulfated alkoxylation products of the alcohols mentioned, known as ether sulfates. Such ether sulfates contain preferably from 2 to 30, in particular from 4 to 10, ethylene glycol groups per molecule. The suitable sulfonate-type anionic surfactants include the a-sulfo esters obtainable by reaction of fatty acid esters with sulfur trioxide and subsequent neutralization, in particular the sulfonation products derived from fatty acids having from 8 to 22 carbon atoms, preferably from 12 to 18 carbon atoms, and linear alcohols having from 1 to 6 carbon atoms, preferably from 1 to 4 carbon atoms, and also the sulfo fatty acids arising from these by hydrolysis in a formal sense.

Useful further optional surfactant ingredients include soaps, suitable soaps being saturated fatty acid soaps such as the salts of lauric acid, myristic acid, palmitic acid or stearic acid, and also soaps derived from natural fatty acid mixtures, for example coconut, palm kernel or tallow fatty acids. In particular, preference is given to soap mixtures which are composed of from 50% by weight to 100% by weight of saturated C₁₂-C₁₈ fatty acid soaps and up to 50% by weight of oleic acid soap. Soap is present preferably in amounts of from 0.1% by weight to 5% by weight. Especially in liquid compositions which comprise a polymer used in accordance with the invention, higher amounts of soap of generally up to 20% by weight may, however, also be present.

If desired, the compositions may also comprise betaines and/or cationic surfactants which, if present, are used preferably in amounts of from 0.5% by weight to 7% by weight. Among these, the ester quats discussed below are particularly preferred.

In a further embodiment, the composition comprises water-soluble and/or water-insoluble builders, in particularly selected from alkali metal aluminosilicate, crystalline alkali metal silicate having a modulus greater than 1, monomeric polycarboxylate, polymeric polycarboxylate and mixtures thereof, in particular in amounts in the range from 2.5% by weight to 60% by weight.

The composition contains preferably from 20% by weight to 55% by weight of water-soluble and/or water-insoluble, organic and/or inorganic builders. The water-soluble organic builder substances include in particular those from the class of the polycarboxylic acids, in particular citric acid and sugar acids, and of the polymeric (poly)carboxylic acids, in particular the polycarboxylates obtainable by oxidation of polysaccharides of the international patent application WO 93/16110, polymeric acrylic acids, methacrylic acids, maleic acids and copolymers thereof, which may also contain small fractions of polymerizable substances without carboxylic acid functionality in copolymerized form. The relative molecular mass of the homopolymers of unsaturated carboxylic acids is generally between 5000 and 200 000, that of the copolymers between 2000 and 200 000, preferably from 50 000 to 120 000, based on the free acid. A particularly preferred acrylic acid-maleic acid copolymer has a relative molecular mass of from 50 000 to 100 000. Suitable, although less preferred, compounds of this class are copolymers of acrylic acid or methacrylic acid with vinyl ethers, such as vinyl methyl ethers, vinyl esters, ethylene, propylene and styrene, in which the fraction of the acid is at least 50% by weight. The water-soluble organic builder substances used may also be terpolymers which contain, as monomers, two carboxylic acids and/or salts thereof and also, as a third monomer, vinyl alcohol and/or a vinyl alcohol derivative or a carbohydrate. The first acidic monomer or its salt derives from a monoethylenically unsaturated C₃-C₈-carboxylic acid and preferably from a C₃-C₄-monocarboxylic acid, in particular from (meth)acrylic acid. The second acidic monomer or its salt may be a derivative of a C₄-C₈-dicarboxylic acid, particular preference being given to maleic acid. The third monomeric unit is formed in this case by vinyl alcohol and/or preferably an esterified vinyl alcohol. Preference is given in particular to vinyl alcohol derivatives which constitute an ester of short-chain carboxylic acids, for example of C₁-C₄-carboxylic acids, with vinyl alcohols. Preferred terpolymers contain from 60% by weight to 95% by weight, in particular from 70% by weight to 90% by weight, of (meth)acrylic acid or (meth)acrylate, more preferably acrylic acid or acrylate, and maleic acid or maleate, and also from 5% by weight to 40% by weight, preferably from 10% by weight to 30% by weight, of vinyl alcohol and/or vinyl acetate. Very particular preference is given to terpolymers in which the weight ratio of (meth)acrylic acid or (meth)acrylate to maleic acid or maleate is between 1:1 and 4:1, preferably between 2:1 and 3:1 and in particular between 2:1 and 2.5:1. Both the amounts and the weight ratios are based on the acids. The second acidic monomer or its salt may also be a derivative of an allylsulfonic acid which is 2-substituted by an alkyl radical, preferably by a C₁-C₄-alkyl radical, or an aromatic radical which preferably derives from benzene or benzene derivatives. Preferred terpolymers contain from 40% by weight to 60% by weight, in particular from 45 to 55% by weight, of (meth)acrylic acid or (meth)acrylate, more preferably acrylic acid or acrylate, from 10% by weight to 30% by weight, preferably from 15% by weight to 25% by weight, of methallylsulfonic acid or methallylsulfonate, and, as a third monomer, from 15% by weight to 40% by weight, preferably from 20% by weight to 40% by weight, of a carbohydrate. This carbohydrate may be, for example, a mono-, di-, oligo- or polysaccharide, preference being given to mono-, di- or oligosaccharides, particular preference to sucrose. The use of the third monomer is presumed to incorporate intended breakage sites in the polymer, which are responsible for good biodegradability of the polymer. These terpolymers can be prepared in particular by processes which are described in the German patent DE 42 21 381 and the German patent application DE 43 00 772, and generally have a relative molecular mass between 1000 and 200 000, preferably between 200 and 50 000 and in particular between 3000 and 10 000. Especially for the preparation of liquid compositions, they may be used in the form of aqueous solutions, preferably in the form of 30 to 50 percent by weight aqueous solutions. All polycarboxylic acids mentioned are used generally in the form of their water-soluble salts, in particular their alkali metal salts.

Such organic builder substances are present preferably in amounts of up to 40% by weight, in particular up to 25% by weight and more preferably from 1% by weight to 5% by weight. Amounts close to the upper limit mentioned are used preferentially in pasty or liquid, in particular aqueous, compositions.

The water-insoluble, water-dispersible inorganic builder materials used are in particular crystalline or amorphous alkali metal aluminosilicates, in amounts of up to 50% by weight, preferably not more than 40% by weight, and in particular from 1% by weight to 5% by weight in liquid compositions. Among these, preference is given to the crystalline aluminosilicates in laundry detergent quality, in particular zeolite NaA and optionally NaX. Amounts close to the upper limit mentioned are used preferentially in solid, particulate compositions. Suitable aluminosilicates have in particular no particles having a particle size above 30 mm and consist preferably to an extent of at least 80% by weight of particles having a size below 10 mm. Their calcium binding capacity, which can be determined according to the specifications of the German patent DE 24 12 837, lies in the range from 100 to 200 mg of CaO per gram. Suitable substitutes or partial substitutes for the aluminosilicate mentioned are crystalline alkali metal silicates which may be present alone or in a mixture with amorphous silicates. The alkali metal silicates which can be used as builders in the compositions preferably have a molar ratio of alkali metal oxide to SiO₂ of below 0.95, in particular from 1:1.1 to 1:12, and may be present in amorphous or crystalline form. Preferred alkali metal silicates are the sodium silicates, in particular the amorphous sodium silicates, having a molar Na₂O:SiO₂ ratio of from 1:2 to 1:2.8. Such amorphous alkali metal silicates are commercially available, for example, under the name Portil®. Those having a molar Na₂O:SiO₂ ratio of from 1:1.9 to 1:2.8 can be prepared by the process of the European patent application EP 0 425 427. In the preparation, they are added preferably as a solid and not in the form of a solution. The crystalline silicates used, which may be present alone or in a mixture with amorphous silicates, are preferably crystalline sheet silicates of the general formula Na₂SiₓO₂ₓ₊₁.yH₂O, in which x, known as the modulus, is from 1.9 to 4 and y is from 0 to 20, and preferred values of x are 2, 3 or 4. Crystalline sheet silicates which fall under this general formula are described, for example, in the European patent application EP 0 164 514. Preferred crystalline sheet silicates are those in which x in the general formula mentioned assumes the value of 2 or 3. Preference is given in particular to both β- and δ-sodium disilicates (Na₂Si₂O₅.yH₂O), and β-sodium disilicate can be obtained, for example, by the process which is described in the international patent application WO 91/08171. δ-Sodium silicates having a modulus between 1.9 and 3.2 can be prepared according to the Japanese patent applications JP 04/238 809 or JP 04/260 610. It is also possible to use virtually anhydrous crystalline alkali metal silicates which have been prepared from amorphous alkali metal silicates and are of the above-mentioned general formula in which x is from 1.9 to 2.1, preparable as described in the European patent applications EP 0 548 599, EP 0 502 325 and EP 0 425 428, in compositions which comprise an inventive polymer. In a further preferred embodiment of inventive compositions, a crystalline sodium sheet silicate having a modulus of from 2 to 3 is used, as can be prepared from sand and sodium carbonate by the process of the European patent application EP 0 436 835. Crystalline sodium silicates having a modulus in the range from 1.9 to 3.5, as are obtainable by the processes of the European patent EP 0 164 552 and/or of the European patent application EP 0 294 753, are used in a further preferred embodiment of laundry detergents which comprise a cellulose derivative used in accordance with the invention. Their content of alkali metal silicates is preferably from 1% by weight to 50% by weight and in particular from 5% by weight to 35% by weight, based on anhydrous active substance. If alkali metal aluminosilicate, in particular zeolite, is present as an additional builder substance, the content of alkali metal silicate is preferably from 1% by weight to 15% by weight and in particular from 2% by weight to 8% by weight, based on anhydrous active substance. The weight ratio of aluminosilicate to silicate, based in each case on anhydrous active substances, is then preferably from 4:1 to 10:1. In compositions which comprise both amorphous and crystalline alkali metal silicates, the weight ratio of amorphous alkali metal silicate to crystalline alkali metal silicate is preferably from 1:2 to 2:1 and in particular from 1:1 to 2:1.

In addition to the inorganic builders mentioned, it is possible to use further water-soluble or water-insoluble inorganic substances in the compositions which comprise a cellulose derivative to be used in accordance with the invention, are used together with it or are used in processes according to the invention. Suitable in this context are the alkali metal carbonates, alkali metal hydrogencarbonates and alkali metal sulfates, and also mixtures thereof. Such additional inorganic material may be present in amounts of up to 70% by weight.

In addition, the compositions may comprise further constituents customary in laundry detergents and cleaning compositions. These optional constituents include in particular enzymes, enzyme stabilizers, complexing agents for heavy metals, for example aminopolycarboxylic acids, aminohydroxypolycarboxylic acids, polyphosphonic acids and/or aminopolyphosphonic acids, foam inhibitors, for example organopolysiloxanes or paraffins, solvents, and optical brighteners, for example stilbenedisulfonic acid derivatives. Compositions which comprise a cellulose derivative used in accordance with the invention preferably contain up to 1% by weight, in particular from 0.01% by weight to 0.5% by weight, of optical brighteners, in particular compounds from the class of the substituted 4,4′-bis(2,4,6-triamino-s-triazinyl)stilbene-2,2′-disulfonic acids, up to 5% by weight, in particular from 0.1% by weight to 2% by weight, of complexing agents for heavy metals, in particular aminoalkylenephosphonic acids and the salts thereof, and up to 2% by weight, in particular from 0.1% by weight to 1% by weight, of foam inhibitors, the proportions by weight specified being based in each case on overall composition.

Solvents which are used in particular in liquid compositions are, in addition to water, preferably those which are water-miscible. These include the lower alcohols, for example ethanol, propanol, isopropanol and the isomeric butanols, glycerol, lower glycols, for example ethylene glycol and propylene glycol, and the ethers which can be derived from the compound classes mentioned. In such liquid compositions, the cellulose derivatives used in accordance with the invention are generally in dissolved or suspended form.

Optionally present enzymes are preferably selected from the group comprising protease, amylase, lipase, cellulase, hemicellulase, oxidase, peroxidase or mixtures thereof. The primary use for enzymes is protease obtained from microorganisms such as bacteria or fungi. It can be obtained from suitable microorganisms in a known manner by fermentation processes, which are described, for example, in the German laid-open specifications DE 19 40 488, DE 20 44 161, DE 21 01 803 and DE 21 21 397, the American patents U.S. Pat. No. 3,623,957 and U.S. Pat. No. 4,264,738, the European patent application EP 006 638 and the international patent application WO 91/02792. Proteases are commercially available, for example, under the names BLAP®, Savinase®, Esperase®, Maxatase®, Optimase®, Alcalase®, Durazym® or Maxapem®. The usable lipase can be obtained from Humicola lanuginosa, as described, for example, in the European patent applications EP 258 068, EP 305 216 and EP 341 947, from Bacillus species, as described, for example, in the international patent application WO 91/16422 or the European patent application EP 384 717, from Pseudomonas species, as described, for example, in the European patent applications EP 468 102, EP 385 401, EP 375 102, EP 334 462, EP 331 376, EP 330 641, EP 214 761, EP 218 272 or EP 204 284 or the international patent application WO 90/10695, from Fusarium species, as described, for example, in the European patent application EP 130 064, from Rhizopus species, as described, for example, in the European patent application EP 117 553 or from Aspergillus species, as described, for example, in the European patent application EP 167 309. Suitable lipases are commercially available, for example, under the names Lipolase®, Lipozym®, Lipomax®), Lipex®), Amano® lipase, Toyo-Jozo® lipase, Meito® lipase and Diosynth® lipase. Suitable amylases are commercially available, for example, under the names Maxamyl®, Termamyl®, Duramyl® and Purafect® OxAm. The usable cellulase may be an enzyme obtainable from bacteria or fungi which has a pH optimum preferably in the weakly acidic to weakly alkaline range of from 6 to 9.5. Such cellulases are known, for example, from the German laid-open specifications DE 31 17 250, DE 32 07 825, DE 32 07 847, DE 33 22 950 or the European patent applications EP 265 832, EP 269 977, EP 270 974, EP 273 125 and EP 339 550, and the international patent applications WO 95/02675 and WO 97/14804, and are commercially available under the names Celluzyme®, Carezyme® and Ecostone®.

The customary enzyme stabilizers optionally present, especially in liquid compositions, include amino alcohols, for example mono-, di-, triethanol- and -propanolamine and mixtures thereof, lower carboxylic acids, as known, for example, from the European patent applications EP 376 705 and EP 378 261, boric acid or alkali metal borates, boric acid-carboxylic acid combinations, as known, for example, from the European patent application EP 451 921, boric esters, as known, for example, from the international patent application WO 93/11215 or the European patent application EP 511 456, boronic acid derivatives, as known, for example, from the European patent application EP 583 536, calcium salts, for example the calcium-formic acid combination known from the European patent EP 28 865, magnesium salts, as known, for example, from the European patent application EP 378 262 and/or sulfur-containing reducing agents, as known, for example, from the European patent applications EP 080 748 or EP 080 223.

The suitable foam inhibitors include long-chain soaps, in particular behenic soaps, fatty acid amides, paraffins, waxes, microcrystalline waxes, organopolysiloxanes and mixtures thereof, which may additionally comprise microfine, optionally silanized or otherwise hydrophobized silica. For use in particulate compositions, such foam inhibiters are preferably bound to granular, water-soluble carrier substances, as described, for example, in the German laid-open specification DE 34 36 194, the European patent applications EP 262 588, EP 301 414, EP 309 931 or the European patent EP 150 386.

In a preferred embodiment, a composition into which cellulose derivative to be used in accordance with the invention is incorporated is particulate and contains up to 25% by weight, in particular from 5% by weight to 20% by weight, of bleach, in particular alkali metal percarbonate, up to 15% by weight, in particular from 1% by weight to 10% by weight, of bleach activator, from 20% by weight to 55% by weight of inorganic builder, up to 10% by weight, in particular from 2% by weight to 8% by weight, of water-soluble organic builder, from 10% by weight to 25% by weight of synthetic anionic surfactant, from 1% by weight to 5% by weight of non-ionic surfactant, and up to 25% by weight, in particular from 0.1% by weight to 25% by weight, of inorganic salts, in particular alkali metal carbonate and/or hydrogencarbonate.

In a further preferred embodiment, a composition into which cellulose derivative to be used in accordance with the invention is incorporated, is liquid and contains from 10% by weight to 25% by weight, in particular from 12% by weight to 22.5% by weight, of non-ionic surfactant, from 2% by weight to 10% by weight, in particular from 2.5% by weight to 8% by weight, of synthetic anionic surfactant, from 3% by weight to 15% by weight, in particular from 4.5% by weight to 12.5% by weight, of soap, from 0.5% by weight to 5% by weight, in particular from 1% by weight to 4% by weight, of organic builder, in particular polycarboxylate such as citrate, up to 1.5% by weight, in particular from 0.1% by weight to 1% by weight, of complexing agent for heavy metals, such as phosphonate, and, in addition to optionally present enzyme, enzyme stabilizer, dye and/or fragrance, water and/or water-miscible solvent.

It is also possible to use the combination of said cotton-active soil release-capable cellulose derivative with a polyester-active soil release-capable polymer composed of a dicarboxylic acid and an optionally polymeric diol to enhance the cleaning performance of bleach-containing laundry detergents in the washing of textiles. In the context of inventive compositions and of the process according to the invention, combinations of said cotton-active soil release-capable cellulose derivative with a polyester-active soil release-capable polymer are also possible.

The soil release-capable polymers which are known to be polyester-active and can be used in addition to the cellulose derivative essential to the invention include copolyesters of dicarboxylic acids, for example adipic acid, phthalic acid or terephthalic acid, diols, for example ethylene glycol or propylene glycol, and polydiols, for example polyethylene glycol or polypropylene glycol. The soil release-capable polyesters used with preference include those compounds which are obtainable in a formal sense by esterification of two monomer units, the first monomer being a dicarboxylic acid HOOC—Ph—COOH and the second monomer a diol HO—(CHR¹¹—)ₐOH which may also be present as a polymeric diol H—(O—(CHR₁₁—)ₐ)_{b}OH. In this formula, Ph is an o-, m- or p-phenylene radical which may bear from 1 to 4 substituents selected from alkyl radicals having from 1 to 22 carbon atoms, sulfonic acid groups, carboxyl groups and mixtures thereof, R¹¹ is hydrogen, an alkyl radical having from 1 to 22 carbon atoms and mixtures thereof, a is from 2 to 6 and b is from 1 to 300. In the polyesters obtainable therefrom, preferably both monomer diol units —O—(CHR₁₁—)ₐO— and polymer diol units —(O—(CHR¹¹—)ₐ)_{b}O— are present. The molar ratio of monomer diol units to polymer diol units is preferably from 100:1 to 1:100, in particular from 10:1 to 1:10. In the polymer diol units, the degree of polymerization b is preferably in the range from 4 to 200, in particular from 12 to 140. The molecular weight or the mean molecular weight or the maximum of the molecular weight distribution of preferred soil release-capable polyesters is in the range from 250 to 100 000, in particular from 500 to 50 000. The parent acid of the Ph radical is preferably selected from terephthalic acid, isophthalic acid, phthalic acid, trimellitic acid, mellitic acid, the isomers of sulfophthalic acid, sulfoisophthalic acid and sulfoterephthalic acid, and mixtures thereof. When the acid groups are not part of the ester bonds in the polymer, they are preferably present in salt form, in particular as the alkali metal or ammonium salt. Among these, particular preference is given to the sodium and potassium salts. If desired, instead of the monomer HOOC—Ph—COOH small fractions, in particular not more than 10 mol % based on the proportion of Ph as defined above, of other acids which have at least two carboxyl groups may be present in the soil release-capable polyester. These include, for example, alkylene- and alkenylenedicarboxylic acids such as malonic acid, succinic acid, fumaric acid, maleic acid, glutaric acid, adipic acid, pimelic acid, suberic acid, azelaic acid and sebacic acid. The preferred diols HO—(CHR¹¹—)ₐOH include those in which R¹¹ is hydrogen and a is from 2 to 6, and those in which a is 2 and R¹¹ is selected from hydrogen and the alkyl radicals having from 1 to 10, in particular from 1 to 3, carbon atoms. Among the latter diols, particular preference is given to those of the formula HO—CH₂—CHR¹¹—OH in which R¹¹ is as defined above. The examples of diol components are ethylene glycol, 1,2-propylene glycol, 1,3-propylene glycol, 1,4-butanediol, 1,5-pentanediol, 1,6-hexanediol, 1,8-octanediol, 1,2-decanediol, 1,2-dodecanediol and neopentyl glycol. Among the polymeric diols, particular preference is given to polyethylene glycol having a mean molar mass in the range of from 1000 to 6000.

If desired, the polyesters having the composition as described above may also be end group-capped, in which case useful end groups are alkyl groups having from 1 to 22 carbon atoms and esters of monocarboxylic acids. The parent acids of the end groups bonded by means of ester bonds may be alkyl-, alkenyl- and arylmonocarboxylic acids having from 5 to 32 carbon atoms, in particular from 5 to 18 carbon atoms. These include valeric acid, caproic acid, enanthic acid, caprylic acid, pelargonic acid, capric acid, undecanoic acid, undecenoic acid, lauric acid, lauroleic acid, tridecanoic acid, myristic acid, myristoleic acid, pentadecanoic acid, palmitic acid, stearic acid, petroselic acid, petroselaidic acid, oleic acid, linoleic acid, linolaidic acid, linolenic acid, eleostearic acid, arachic acid, gadoleic acid, arachidonic acid, behenic acid, erucic acid, brassidic acid, clupanodonic acid, lignoceric acid, cerotic acid, melissic acid, benzoic acid which may bear from 1 to 5 substituents having a total of up to 25 carbon atoms, in particular from 1 to 12 carbon atoms, for example tert-butylbenzoic acid. The parent acids of the end groups may also be hydroxymonocarboxylic acids, having from 5 to 22 carbon atoms, which include, for example, hydroxyvaleric acid, hydroxycaproic acid, ricinoleic acid, their hydrogenation product hydroxystearic acid, and also o-, m- and p-hydroxybenzoic acid. The hydroxymonocarboxylic acids may in turn be joined together by means of their hydroxyl group and their carboxyl group and thus be present more than once in one end group. The number of hydroxymonocarboxylic acid units per end group, i.e. their degree of oligomerization, is preferably in the range from 1 to 50, in particular from 1 to 10. In a preferred embodiment of the invention, polymers composed of ethylene terephthalate and polyethylene oxide terephthalate in which the polyethylene glycol units have molar masses of from 750 to 5000 and the molar ratio of ethylene terephthalate to polyethylene oxide terephthalate is from 50:50 to 90:10 are used in combination with the cellulose derivatives.

The soil release-capable polymers are preferably water-soluble, the term “water-soluble” meaning a solubility of at least 0.01 g, preferably at least 0.1 g, of the polymer per liter of water at room temperature and pH 8. However, polymers used with preference have a solubility of at least 1 g per liter, in particular at least 10 g per liter, under these conditions.

Preferred laundry after-treatment compositions which comprise a cellulose derivative to be used in accordance with the invention have, as a laundry-softening active ingredient, an ester quat, i.e. a quaternized ester composed of carboxylic acid and amino alcohol. These are known substances which can be obtained by the relevant methods of preparative organic chemistry. In this context, reference is made to the international patent application WO 91/01295, by which triethanolamine is esterified partly with fatty acids in the presence of hypophosphorous acid, air is passed through and the mixture is subsequently quaternized with dimethyl sulfate or ethylene oxide. Moreover, the German patent DE 43 08 794 discloses a process for preparing solid ester quats in which the quaternization of triethanolamine esters is carried out in the presence of suitable dispersants, preferably fatty alcohols. Reviews on this theme have been published, for example, by R. Puchta et al. in Tens. Surf. Det., 30, 186 (1993), M. Brock in Tens. Surf. Det. 30, 394 (1993), R. Lagerman et al. in J. Am. Oil. Chem. Soc., 71, 97 (1994) and I. Shapiro in Cosm. Toil. 109, 77 (1994).

Ester quats preferred in the compositions are quaternized fatty acid triethanolamine ester salts which follow the formula (I) 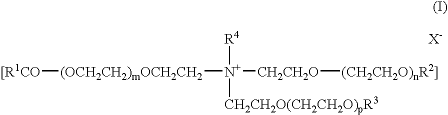
in which R¹CO is an acyl radical having from 6 to 22 carbon atoms, R² and R³ are each independently hydrogen or R¹CO, R⁴ is an alkyl radical having from 1 to 4 carbon atoms or a (CH₂CH₂O)_{q}H group, m, n and p in total are 0 or from 1 to 12, q is from 1 to 12 and X is a charge-balancing anion such as halide, alkylsulfate or alkylphosphate. Typical examples of ester quats which may find use in the context of the invention are products based on caproic acid, caprylic acid, capric acid, lauric acid, myristic acid, palmitic acid, isostearic acid, stearic acid, oleic acid, elaidic acid, arachic acid, behenic acid and erucic acid, and their technical-grade mixtures, as are obtained, for example, in the pressure cleavage of natural fats and oils. Preference is given to using technical-grade C_{12/18} coconut fatty acids and in particular partly hydrogenated C_{16/18} tallow or palm fatty acids, and also elaidic acid-rich C_{16/18} fatty acid cuts. To prepare the quaternized esters, the fatty acids and the triethanolamine can be used generally in the molar ratio of from 1.1:1 to 3:1. With regard to the performance properties of the ester quats, a use ratio of from 1.2:1 to 2.2:1, preferably from 1.5:1 to 1.9:1, has been found to be particularly advantageous. The ester quats used with preference are technical-grade mixtures of mono-, di- and triesters having an average degree of esterification of from 1.5 to 1.9, and derive from technical-grade C_{16/18} tallow or palm fatty acid (iodine number from 0 to 40). Quaternized fatty acid triethanolamine ester salts of the formula (I) in which R¹CO is an acyl radical having from 16 to 18 carbon atoms, R² is R¹CO, R³ is hydrogen, R⁴ is a methyl group, m, n and p are each 0 and X is methylsulfate have been found to be particularly advantageous.

In addition to the quaternized carboxylic acid triethanolamine ester salts, useful ester quats are also quaternized ester salts of carboxylic acids with diethanolalkylamines of the formula (II) 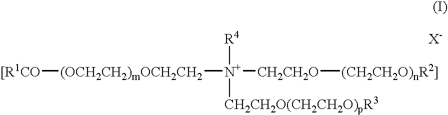
in which R¹CO is an acyl radical having from 6 to 22 carbon atoms, R² is hydrogen or R¹CO, R⁴ and R⁵ are each independently alkyl radicals having from 1 to 4 carbon atoms, m and n in total are 0 or from 1 to 12, and X is a charge-balancing anion such as halide, alkylsulfate or alkylphosphate.

As a further group of suitable ester quats, mention should finally be made of the quaternized ester salts of carboxylic acids with 1,2-dihydroxypropyldialkylamines of the formula (III), 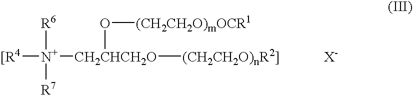
in which R¹CO is an acyl radical having from 6 to 22 carbon atoms, R² is hydrogen or R¹CO, R⁴, R⁶ and R⁷ are each independently alkyl radicals having from 1 to 4 carbon atoms, m and n in total are 0 or from 1 to 12, and X is a charge-balancing anion such as halide, alkylsulfate or alkylphosphate.

With regard to the selection of the preferred fatty acids and of the optimal degree of esterification, the remarks made by way of example for (I) also apply mutatis mutandis to the ester quats of the formulae (II) and (III). Typically, the ester quats are commercially available in the form of 50 to 90 percent by weight alcoholic solutions which can also be diluted with water without any problem, and ethanol, propanol and isopropanol are the customary alcoholic solvents.

Ester quats are used preferably in amounts of from 5% by weight to 25% by weight, in particular from 8% by weight to 20% by weight, based in each case on overall laundry after-treatment composition. If desired, the laundry after-treatment compositions used in accordance with the invention may additionally comprise above-detailed laundry detergent ingredients, as long as they do not interact adversely with the ester quat in an unacceptable manner. They are preferably liquid, water-containing compositions.

### EXAMPLES

### Example 1

A laundry detergent (V1) comprising

| | | |
|---|---|---|
| ABS | 12 | parts by weight |
| FAS | 5 | parts by weight |
| C12/14 7 EO | 3 | parts by weight |
| TAED | 7 | parts by weight |
| Percarbonate | 17 | parts by weight |
| Sodium carbonate | 13 | parts by weight |
| Zeolite | 28 | parts by weight |
| Sokalan ® CP 5^{a)} | 5 | parts by weight |
| Tinopal ® DMS-X^{b)} | 0.2 | part by weight |

^{a)}Polymeric polycarboxylate, manufacturer: BASF AG
^{b)}Optical brightener, manufacturer: Ciba

was admixed with 2 parts by weight of methylhydroxyethylcellulose, mean molar mass 95 000 (W1) or with 2 parts by weight of methylhydroxypropylcellulose, mean molar mass 50 000 (W2). For comparison, a laundry detergent V2 was also prepared from V1 by adding 2 parts by weight of polyethylene terephthalate-polyoxyethylene glycol copolymer (Repel-O-Tex®). Fabric of pure cotton, finished cotton and 50/50 polyester/cotton mixed fabric were treated as follows:

| | |
|---|---|
| Washing machine: | Miele W 918 Novotronic ® |
| Primary wash: | Standard program, single-liquor process |
| Wash temperature: | 40° C. |
| Determination: | 5-fold |
| Liquor volume: | 18 l |
| Water hardness: | 16° German hardness |
| Ballast: | 3.5 kg of clean laundry |

The unstained fabrics were washed three times under the above-specified conditions with the laundry detergent to be tested in each case and dried after each wash. After the threefold prewash, the fabrics were stained by hand with the following standardized stains:
0.10 g of lipstick
0.10 g of black shoe polish
0.10 g of dust/sebum
The stained fabrics were measured with a Minolta CR 200 and subsequently aged at RT for 7 days. Afterward, the stained fabrics were tacked onto towels and washed under the above-specified conditions.

The fabrics were dried and measured again with a Minolta CR 200. The following wash results were obtained (dde values):

TABLE 1
pure cotton

| | Lipstick | Black shoe polish | Dust/sebum |
|---|---|---|---|
| V1 | 60.5 | 54.9 | 55.6 |
| V2 | 57.5 | 54.8 | 57.9 |
| W1 | 66.0 | 58.0 | 59.7 |
| W2 | 66.5 | 60.2 | 61.0 |

TABLE 2
finished cotton

| | Lipstick | Black shoe polish | Dust/sebum |
|---|---|---|---|
| V1 | 70.0 | 56.0 | 48.8 |
| V2 | 67.9 | 55.9 | 48.7 |
| W1 | 77.5 | 58.8 | 61.1 |
| W2 | 81.1 | 59.9 | 60.8 |

TABLE 3
cotton/polyester

| | Lipstick | Black shoe polish | Dust/sebum |
|---|---|---|---|
| V1 | 66.2 | 54.4 | 46.7 |
| V2 | 71.2 | 55.1 | 58.0 |
| W1 | 73.2 | 58.2 | 60.7 |
| W2 | 77.2 | 57.4 | 58.8 |

It can be seen that the laundry detergents comprising the cellulose derivative to be used in accordance with the invention (W1 and W2) exhibit distinctly better washing performance than the composition which lacks it (V1) or which comprises a polyester in its stead (V2).

### Example 2

As in example 1, washing experiments were carried out, except that the unsoiled fabric was washed three times with the laundry detergent V1 but additionally with cellulose derivative-containing softener S1 (15% by weight of ester quat and 2% by weight of the methylhydroxyethylcellulose utilized in example 1 in water) or with the same softener which lacked the cellulose derivative (S0), and dried after each wash. Subsequently, the fabrics were stained with the standardized stains, and the stained fabrics were measured with a Minolta CR 200, aged at RT for 7 days, then tacked onto towels and washed with V1 under the conditions specified in example 1 and rinsed with S1 or S0.

The fabrics were dried and measured again with a Minolta CR 200. This gave the following wash results (dde values):

TABLE 4
pure cotton

| | Lipstick | Black shoe polish | Dust/sebum |
|---|---|---|---|
| S0 | 60.5 | 54.9 | 55.6 |
| S1 | 77.8 | 57.1 | 61.2 |

TABLE 5
finished cotton

| | Lipstick | Black shoe polish | Dust/sebum |
|---|---|---|---|
| S0 | 70.0 | 56.0 | 48.8 |
| S1 | 88.2 | 58.5 | 54.2 |

TABLE 6
cotton/polyester

| | Lipstick | Black shoe polish | Dust/sebum |
|---|---|---|---|
| S0 | 66.2 | 54.4 | 46.7 |
| S1 | 80.3 | 56.9 | 65.3 |

It can be seen that the use of the laundry after-treatment composition comprising the cellulose derivative to be used in accordance with the invention gives rise to distinctly better washing performance than the use of the laundry after-treatment composition lacking the cellulose derivative.

### Example 3

A laundry detergent (V3) comprising

| | | |
|---|---|---|
| ABS | 11 | parts by weight |
| FAS | 5 | parts by weight |
| C12/14 7 EO | 4 | parts by weight |
| Sodium carbonate | 4 | parts by weight |
| Zeolite | 22 | parts by weight |
| Sodium citrate | 2 | parts by weight |
| Sokalan ® CP 5^{a)} | 2 | parts by weight |
| Enzyme^{b)} | 1.5 | parts by weight |

^{a)}Polymeric polycarboxylate, manufacturer: BASF AG
^{b)}Combination of protease, amylase and cellulase

was mixed with 18 parts by weight of sodium percarbonate and 8 parts by weight of TAED (laundry detergent V4). Addition of 2 parts by weight of methylhydroxyethylcellulose (DS 1.89; MS 0.15; mean molar mass 100 000) to V3 and V4 prepared the laundry detergents V5 and W3 respectively from these. As described in example 1, washing experiments were carried out with these compositions. This gave the following wash results (dde values):

TABLE 7
pure cotton

| | Lipstick | Dust/sebum |
|---|---|---|
| V3 | 53.4 | 56.6 |
| V4 | 66.7 | 57.7 |
| V5 | 51.7 | 57.1 |
| W3 | 72.8 | 63.1 |

TABLE 8
finished cotton

| | Lipstick | Dust/sebum |
|---|---|---|
| V3 | 54.6 | 47.3 |
| V4 | 66.7 | 44.2 |
| V5 | 55.4 | 48.6 |
| W3 | 78.9 | 53.2 |

TABLE 9
cotton/polyester

| | Lipstick | Dust/sebum |
|---|---|---|
| V3 | 63.6 | 51.4 |
| V4 | 71.1 | 48.5 |
| V5 | 67.9 | 56.9 |
| W3 | 76.3 | 58.3 |

It can be seen that the laundry detergents comprising the cellulose derivative (V5 and W3) do exhibit better washing performance in the vast majority of cases than the corresponding compositions which lack it (V3 and V4), but that the bleach-containing composition comprising the cellulose derivative (W3) used in accordance with the invention gives rise to the best performance.

1. A method of cleaning a textile material comprising contacting a textile material comprised at least partially of cotton with a laundry detergent comprising bleach and an alkylated and/or hydroxyalkylated soil release-capable cellulose derivative having an average of from 0.5 to 2.5 alkyl groups and/or from 0.02 to 0.5 hydroxyalkyl groups per anhydroglycose monomer unit.

2. The method of claim 1 wherein the textile material is pre-washed and/or after treated in the presence of the cellulose derivative prior to being soiled.

3. The method of claim 1 wherein the laundry detergent is further comprised of a polyester-active soil release-capable polymer comprised of a dicarboxylic acid and an optionally polymeric diol.

4. The method of claim 1 wherein the alkyl group of the alkylated cellulose derivative is a C₁ to C₁₀ group and the hydroxyalkyl group of the hydroxyalkylated cellulose derivative is a C₂ to C₁₀ hydroxyalkyl group.

5. The method of claim 4 wherein the hydroxyalkyl group of the hydroxyalkylated cellulose derivative is a C₂ to C₃ hydroxyalkyl group.

6. The method of claim 1 wherein the cellulose derivative is comprised of an average of from 1 to 2 alkyl groups and from 0.05 to 0.3 hydroxyalkyl groups per anhydroglycose monomer unit.

7. The method of claim 1 wherein the mean molar mass of the cellulose derivative is from 10,000 D to 150 000 D.

8. The method of claim 7 wherein the mean molar mass of the cellulose derivative is from 40,000 D to 120,000 D

9. The method of claim 8 wherein the mean molar mass of the cellulose derivative is from 80,000 D to 110,000 D

10. The method of claim 1 wherein the amount of bleach is from 5% by weight to 70% by weight.

11. The method of claim 11 wherein the laundry detergent is further comprised of from 2% by weight to 10% by weight of a bleach activator.

12. A method of cleaning a textile material comprising the steps of: (1) contacting a textile material comprised at least partially of cotton with a laundry detergent comprising bleach and an alkylated and/or hydroxyalkylated soil release-capable cellulose derivative having an average of from 0.5 to 2.5 alkyl groups and/or from 0.02 to 0.5 hydroxyalkyl groups per anhydroglycose monomer unit; (2) contacting the clean textile material from step (1) with a composition comprised of an alkylated and/or hydroxyalkylated soil release-capable cellulose derivative having an average of from 0.5 to 2.5 alkyl groups and/or from 0.02 to 0.5 hydroxyalkyl groups per anhydroglycose monomer unit.

13. The method of claim 12 wherein the composition of step (2) is further comprised of an ester quat.

14. The method of claim 13 wherein the ester quat is present in an amount of from 5% by weight to 25% by weight.

15. The process of claim 14 wherein the amount of the ester quat is from 8% by weight to 20% by weight.

16. The method of claim 12 wherein the laundry detergent is comprised of from 0.1% by weight of the cellulose derivative.

17. The method of claim 16 wherein the amount of the cellulose derivative is from 0.5% by weight to 2.5% by weight.

18. The method of claim 12 wherein the amount of bleach is from 5% by weight to 70% by weight

19. The method of claim 18 wherein the laundry detergent is further comprised of from 2% by weight to 10% by weight of a bleach activator.

20. A composition for cleaning a textile material comprising bleach and an alkylated and/or hydroxyalkylated soil release-capable cellulose derivative having an average of from 0.5 to 2.5 alkyl groups and/or from 0.02 to 0.5 hydroxyalkyl groups per anhydroglycose monomer unit.
